(19) United States
(12) Patent Application Publication
(10) Pub. No.: US 2026/0004369 A1
(43) Pub. Date: Jan. 1, 2026

(54) MULTI-AGENT REINFORCEMENT LEARNING-BASED MOBILE ELECTRIC VEHICLE CHARGING SERVICE METHOD

(71) Applicants: HYUNDAI MOTOR COMPANY, Seoul (KR); Kia Corporation, Seoul (KR); Gwangju Institute of Science and Technology, Gwangju (KR)

(72) Inventors: Jaehyuk Choi, Gyeonggi-do (KR); Euiseok Hwang, Gwangju (KR); Seungwook Yoon, Gwangju (KR); Dongju Kim, Gwangju (KR)

(73) Assignees: HYUNDAI MOTOR COMPANY, Seoul (KR); Kia Corporation, Seoul (KR); Gwangju Institute of Science and Technology, Gwangju (KR)

(21) Appl. No.: 18/955,598

(22) Filed: Nov. 21, 2024

(30) Foreign Application Priority Data
Jun. 28, 2024 (KR) 10-2024-0085119

(51) Int. Cl. G06Q 50/06; B60L 53/57; B60L 53/64; G06N 3/092; G06Q 30/0202; G06Q 30/0217; G06Q 50/40

(52) U.S. Cl. CPC G06Q 50/06; B60L 53/64; G06N 3/092; G06Q 30/0202; G06Q 50/40; B60L 53/57; G06Q 30/0217

(57) ABSTRACT

A multi-agent reinforcement learning-based mobile electric vehicle charging service method may include: generating an electric vehicle charging demand; detecting a state of a mobile charging station; and determining an action of the mobile charging station including moving or waiting based on the electric vehicle charging demand and the state of the mobile charging station. The method may further include: paying a reward as a feedback with respect to a result including a charging profit and a moving cost based on the determined action; storing and accumulating the action, the result, and the reward as learning data; and training a multi-agent reinforcement learning model for generating the optimal deployment of the mobile charging station by using the accumulated learning data.

### CROSS-REFERENCE TO RELATED APPLICATION

This application claims priority to and the benefit of Korean Patent Application No. 10-2024-0085119 filed in the Korean Intellectual Property Office on Jun. 28, 2024, the entire contents of which are incorporated herein by reference.

### BACKGROUND

### (a) Technical Field

The present disclosure relates to a multi-agent reinforcement learning-based mobile electric vehicle charging service method. More particularly, the present disclosure relates to an operation scheduling and simulation method to provide a vehicle-to-vehicle electric vehicle charging (V2V EV charging) service through a mobile charging station (MCS).

### (b) Description of the Related Art

As electric vehicle technology advances, issues such as maximum driving range are being solved, leading to the wider adoption of electric vehicles. However, the expansion of charging facilities cannot keep pace with the increasing number of electric vehicles.

In this environment, an electric vehicle charger fixed in one location cannot effectively address the increasing demand for electric vehicle charging. The distribution and efficient operation of mobile electric vehicle chargers is expected to effectively address the charging demand problem.

Recently, there has been significant research and invention focused on using EV batteries not only for driving, but also for discharging power to external facilities other than the electric vehicle (buildings, power grids, and the like) to discharge power.

Currently, vehicle-to-vehicle electric vehicle charging (V2V EV charging), which charges another electric vehicle with the battery of an electric vehicle, has also been developed and distributed, providing an environment in which vehicle-to-vehicle charging can be used.

Therefore, mobile electric vehicle charging can be distributed and utilized through electric vehicles equipped with batteries for vehicle-to-vehicle charging. Optimization of efficient placement and movement of these mobile electric vehicle charging vehicles is desired.

### SUMMARY

The present disclosure provides a service model for obtaining charging profit through efficient electric vehicle charging utilizing multi-agent reinforcement learning technology and a simulation system for generating reinforcement learning data and calculating the expected profit.

The present disclosure provides a multi-agent reinforcement learning-based mobile electric vehicle charging service method capable of obtaining charging profit by disposing mobile electric vehicle charging vehicles in a region of high electric vehicle charging demand by time zone in order to provide a vehicle-to-vehicle electric vehicle charging service.

A multi-agent reinforcement learning-based mobile electric vehicle charging service method may include: generating an electric vehicle charging demand; detecting a state of a mobile charging station; and determining an action of the mobile charging station including moving or waiting based on the electric vehicle charging demand and the state of the mobile charging station. The method may further include: paying a reward as feedback to a result including a charging profit and a moving cost based on the determined action; storing and accumulating the action, the result, and the reward as learning data; and training a multi-agent reinforcement learning model for generating the optimal deployment of the mobile charging station by using the accumulated learning data.

Generating the electric vehicle charging demand includes: collecting data with respect to the electric vehicle charging demand and a traffic amount; predicting an electric vehicle charging amount through an artificial intelligence model based on the collected data; and generating an electric vehicle charging demand probability model based on the predicted electric vehicle charging amount. Generating the electric vehicle charging demand also includes generating the electric vehicle charging demand by using the generated electric vehicle charging demand probability model.

The electric vehicle charging demand probability model may include a Poisson distribution model.

Determining the action of the mobile charging station may include determining the action through the multi-agent reinforcement learning model including a Deep Q Network, a Dueling Q Network, and an Actor-Critic Model.

Paying the reward may include calculating a future value based on the action of the mobile charging station and the electric vehicle charging demand, respectively, and paying the reward with respect to the action in proportion to the calculated future value.

Paying the reward may include determining the reward based on Equation 1:

$${R}_{Agent} = {R}_{Action} + {R}_{State} ,$$

where the term agent means an electric vehicle charging station, R_{Agent} means the reward obtained by respective agents, R_{Action} is an agent action reward, and R_{State} is an agent state reward. R_{Action} is proportional to a charging service providing profit, and inversely proportional to an agent moving cost, and R_{State} is proportional to the number of remaining electric vehicles for charging and inversely proportional to the number of agents.

Accumulating as the learning data may include performing a simulation to generate the electric vehicle charging demand over time in an N×M grid environment, and to generate the reward based on a movement of the mobile charging station and provision of the charging service, for accumulation of the learning data.

Performing the simulation may include calculating the electric vehicle charging demand and a deployment of the mobile charging stations as a 2-dimension matrix matching the N×M grid environment.

Performing the simulation may further include calculating both the charging profit and the moving cost based on the movement of the mobile charging station and the provision of the charging service, and determining the reward based on the calculated charging profit and the moving cost.

Training the multi-agent reinforcement learning model may further include training the multi-agent reinforcement learning model in a direction to maximize the reward through repetitive simulation.

A multi-agent reinforcement learning-based mobile electric vehicle charging service method may include: providing a multi-agent reinforcement learning model trained based on electric vehicle charging demand information and state information of the mobile charging station to generate an optimal deployment of mobile charging stations. The method may also include disposing the mobile charging station by using the multi-agent reinforcement learning model, when an electric vehicle charging request is received.

Disposing the mobile charging station may include providing the charging service by moving a plurality of mobile charging stations, respectively, based on a plurality of electric vehicle charging demands provided at each grid in an N×M grid environment.

The plurality of electric vehicle charging demands and the plurality of mobile charging stations in the N×M grid environment are provided as a 2-dimensional matrix matching the N×M grid environment.

The disposing the mobile charging station may include disposing the mobile charging station at a location to maximize a charging profit based on a movement of the mobile charging station and the provision of the charging service and to minimize a moving cost, by using the multi-agent reinforcement learning model.

Providing the multi-agent reinforcement learning model may include training the multi-agent reinforcement learning model. Training the multi-agent reinforcement learning model may include: detecting a state of the mobile charging station; determining an action of the mobile charging station including moving or waiting based on the electric vehicle charging demand and the state of the mobile charging station; and paying a reward as a feedback with respect to a result including a charging profit and a moving cost based on the determined action. Training the multi-agent reinforcement learning model may include: storing and accumulating the action, the result, and the reward as learning data; and training the multi-agent reinforcement learning model for generating the optimal deployment of the mobile charging station by using the accumulated learning data.

Generating the electric vehicle charging demand may include: collecting data with respect to the electric vehicle charging demand and a traffic amount; predicting an electric vehicle charging amount through an artificial intelligence model based on the collected data; and generating an electric vehicle charging demand probability model based on the predicted electric vehicle charging amount. Additionally, generating the electric vehicle charging demand may include generating the electric vehicle charging demand by using the generated electric vehicle charging demand probability model.

Determining the action of the mobile charging station may include determining the action through the reinforcement learning model including a Deep Q Network, a Dueling Q Network, and an Actor-Critic Model.

Paying the reward may include calculating a future value including the charging profit based on the action of the mobile charging station and the electric vehicle charging demand, respectively, and paying the reward with respect to the action in proportion to the calculated future value.

Paying the reward may include determining the reward based on Equation 1:

$${R}_{Agent} = {R}_{Action} + {R}_{State} .$$

Agent means an electric vehicle charging station, R_{Agent} means the reward obtained by respective agents, R_{Action} is an agent action reward, and R_{State} is an agent state reward. R_{Action} may be proportional to a charging service providing profit, and may be inversely proportional to an agent moving cost, and R_{State} is proportional to the number of remaining electric vehicles for charging and inversely proportional to the number of agents.

The training of the multi-agent reinforcement learning model may include performing a simulation to generate the electric vehicle charging demand over time in an N×M grid environment and to generate the reward based on a movement of the mobile charging station and provision of the charging service, for accumulation of the learning data.

A multi-agent reinforcement learning-based mobile electric vehicle charging service method based on an embodiment may raise the charging profit by disposing a mobile electric vehicle charging vehicle in a region of high electric vehicle charging demand by time zone, and may contribute to spreading of the electric vehicle by efficiently solving range anxiety of the electric vehicle.

A multi-agent reinforcement learning-based mobile electric vehicle charging service method based on an embodiment may provide a mobile electric vehicle charging service in various situations such as when a fixed electric vehicle charging station is in a far distance or in an overload state, thereby reducing the total cost (movement, time, charging cost, or the like) for charging.

### BRIEF DESCRIPTION OF THE DRAWINGS

The above and other objectives, features, and other advantages of the present disclosure should be more clearly understood from the following detailed description when taken in conjunction with the accompanying drawings.

FIG. 1 schematically shows a multi-agent reinforcement learning-based mobile electric vehicle charging service operation system according to an embodiment.

FIGS. 2 and 3 are flowcharts of a multi-agent reinforcement learning-based mobile electric vehicle charging service method according to an embodiment.

FIG. 4 is a flowchart of a multi-agent reinforcement learning-based mobile electric vehicle charging service method according to an embodiment.

FIGS. 5A, 5B, and 5C are diagrams explaining a multi-agent reinforcement learning-based mobile electric vehicle charging service method according to an embodiment.

FIGS. 6 and 7 are drawings showing results obtained through a multi-agent reinforcement learning-based mobile electric vehicle charging service method according to an embodiment.

FIG. 8 is a drawing explaining a computing device according to an embodiment.

### DETAILED DESCRIPTION

Embodiments of the present disclosure are described hereinafter with reference to the accompanying drawings such that a person having ordinary skill in the art may easily implement the embodiments. Those having ordinary skill in the art should understand, the described embodiments may be modified in various different ways, all without departing from the spirit or scope of the present disclosure. In order to clarify the present disclosure, parts that are not related to the description have been omitted, and the same elements or equivalents are referred to with the same reference numerals throughout the specification.

In addition, unless explicitly described to the contrary, the word “comprise” and variations such as “comprises” or “comprising” should be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit,” “part,” “portion,” or “module” in the specification refer to a unit that processes at least one function or operation, which may be implemented by hardware, software, or a combination of hardware and software.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, embodiments of the present disclosure are described with reference to the drawings.

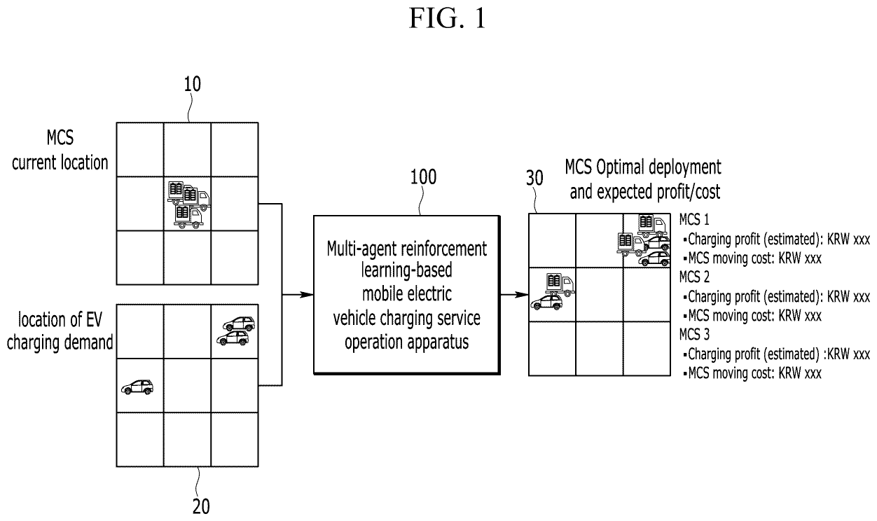

FIG. 1 schematically shows a multi-agent reinforcement learning-based mobile electric vehicle charging service operation system according to an embodiment.

Referring to FIG. 1, a multi-agent reinforcement learning-based mobile electric vehicle charging service operation system may generate an optimal deployment of the mobile charging station. The system maximizes a charging profit and minimizes a moving cost based on a current location 10 of a mobile charging station (MCS) and a location 20 of the electric vehicle (EV) requiring charging by using a multi-agent reinforcement learning model. The multi-agent reinforcement learning model is based on a multi-agent reinforcement learning-based mobile electric vehicle charging service method.

The multi-agent reinforcement learning-based mobile electric vehicle charging service method may be an operation scheduling and simulation method for providing a vehicle-to-vehicle electric vehicle charging (V2V EV charging) service through the mobile charging station (MCS).

The multi-agent reinforcement learning-based mobile electric vehicle charging service method may be a service model for obtaining the charging profit through efficient electric vehicle charging utilizing the multi-agent reinforcement learning technology. The method may include a simulation for generating reinforcement learning data and calculating an expected profit.

The multi-agent reinforcement learning-based mobile electric vehicle charging service method may be performed through a multi-agent reinforcement learning-based mobile electric vehicle charging service operation apparatus 100. The multi-agent reinforcement learning-based mobile electric vehicle charging service operation apparatus 100 may be a server or computing device that performs the multi-agent reinforcement learning-based mobile electric vehicle charging service method.

The multi-agent reinforcement learning-based mobile electric vehicle charging service method may train the multi-agent reinforcement learning model based on various information pieces. The multi-agent reinforcement learning-based mobile electric vehicle charging service method may be a method for finally disposing the mobile charging station at an optimal location in various situations by using the trained multi-agent reinforcement learning model.

The multi-agent reinforcement learning-based mobile electric vehicle charging service method may be a method of training the multi-agent reinforcement learning model based on a state of the mobile charging station and an electric vehicle charging demand.

The multi-agent reinforcement learning-based mobile electric vehicle charging service method may be a method of disposing the mobile charging station based on the electric vehicle charging demand.

The multi-agent reinforcement learning-based mobile electric vehicle charging service method may be a method of calculating the expected profit and the moving cost through a deployment of the mobile charging stations based on the electric vehicle charging demand.

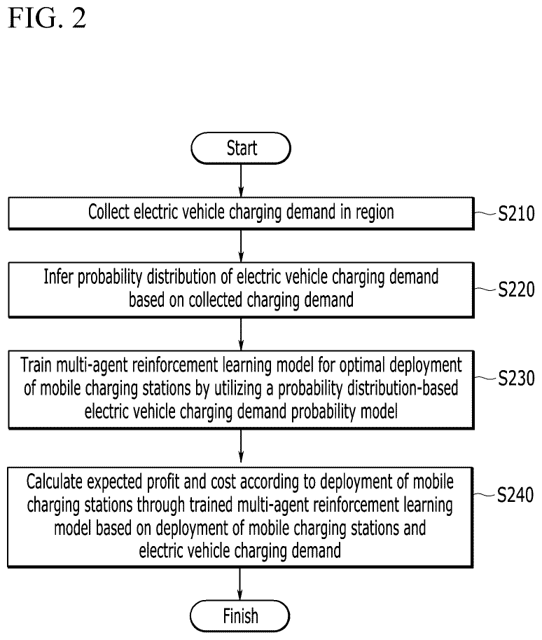

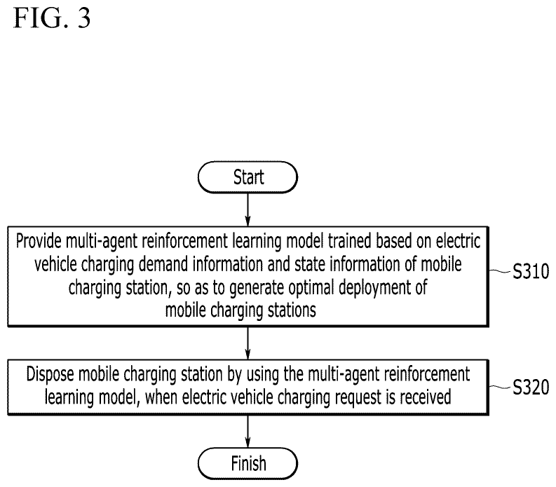

FIGS. 2 and 3 are flowcharts of the multi-agent reinforcement learning-based mobile electric vehicle charging service method according to an embodiment.

FIG. 2 is a flowchart for a multi-agent reinforcement learning method through the multi-agent reinforcement learning-based mobile electric vehicle charging service method.

The multi-agent reinforcement learning-based mobile electric vehicle charging service method of FIG. 2 may be performed through the multi-agent reinforcement learning-based mobile electric vehicle charging service operation apparatus 100 (see FIG. 1).

In FIG. 2, at step S210, the multi-agent reinforcement learning-based mobile electric vehicle charging service operation apparatus 100 may collect the electric vehicle charging demand within the region.

At step S220, the multi-agent reinforcement learning-based mobile electric vehicle charging service operation apparatus 100 may infer the probability distribution of the electric vehicle charging demand based on the collected charging demand.

The multi-agent reinforcement learning-based mobile electric vehicle charging service operation apparatus 100 may infer the probability distribution of the electric vehicle charging demand by using the electric vehicle charging demand probability model.

The electric vehicle charging demand probability model may be a model for predicting and managing the charging demand of electric vehicles. The electric vehicle charging demand probability model may estimate the charging demand in a specific time zone or location in consideration of various factors.

For example, the electric vehicle charging demand probability model may estimate the charging demand in consideration of dissemination data of electric vehicles. In other words, the electric vehicle charging demand probability model may establish the model based on data such as dissemination status and growth trend of electric vehicles, electric vehicle model and driving pattern, or the like.

The electric vehicle charging demand probability model may estimate the charging demand based on charging infrastructure data. In other words, the electric vehicle charging demand probability model may utilize data, such as location, type, usage for each charging time zone, or the like, of the charging station, to the model.

The electric vehicle charging demand probability model may estimate the charging demand based on power demand data for time zones and regions. In other words, the electric vehicle charging demand probability model may be modeled in consideration of the power demand pattern at a specific time zone and region.

The electric vehicle charging demand probability model may also include factors, such as charging price, electricity rate system, volatility of energy market, which are economic factors, in the model.

The electric vehicle charging demand probability model may also consider climate and traffic data. In other words, the external factors such as climate condition and traffic congestion may affect the charging demand. These data may also be used in the modeling of the electric vehicle charging demand probability model.

In addition, the electric vehicle charging demand probability model may include a charging action model. In other words, the electric vehicle charging demand probability model may model the charging action of the electric vehicle owner. The charging action may include variables such as a charging start time, a charging period, and a charging amount.

The modeling of the electric vehicle charging demand probability model may be performed through statistical techniques, machine learning, or simulations. According to given data and modeling techniques, the electric vehicle charging demand probability model may predict the actual charging demand with sufficient confidence and flexibility. Based on this, the electric vehicle charging demand probability model may be utilized for establishing expansion and operation plan of the charging infrastructure.

At step S230, the multi-agent reinforcement learning-based mobile electric vehicle charging service operation apparatus 100 may train the multi-agent reinforcement learning model for the optimal deployment of the mobile charging station by utilizing a probability distribution-based on the electric vehicle charging demand probability model.

Multi-agent reinforcement learning (MARL) is a field of reinforcement learning, and may be a technique in which many agents perform the reinforcement learning in the interacting environment. The multi-agent reinforcement learning (MARL) may be applied to solve complex problems where multiple agents interact with different perspectives and goals.

Agents are individual entities that interact with the environment to select actions and receive rewards. The goal of an agent is to change the environment by selecting a specific action in a given state and thereby maximize the reward.

The environment is a space where agents interact, and the state changes and rewards are given depending on the agent's actions. The environment can update its state and provide the next state after an agent has taken the action.

The state is a state of observable information when the agents interact with the environment. Each agent may observe the state and may select actions based on this.

The action is an action or decision selected by the agent in a specific state, and the goal of the agent is to select an optimal action maximizing the reward.

The reward is a value that the agent receives when a specific action is taken at a specific state. In the reinforcement learning, the agent may proceed with learning in a direction toward the goal of maximizing the reward.

Techniques of the multi-agent reinforcement learning may include an independent learning, a centralized learning, and a distributed learning.

The independent learning may be a method in which the agent individually performs the reinforcement learning, respectively. The agents may proceed with learning without considering each other's actions.

The centralized learning is a method of centrally managing and controlling the learning of all the agents. The action of the agents may be coordinated in consideration of the entire system.

The distributed learning is a method in which the agents individually proceed with learning in a distributed environment. The agents may perform the training by using only the local information, and unlike the centralized learning, may not consider the strategy of the entire system.

In the multi-agent reinforcement learning-based mobile electric vehicle charging service method, the agent may be the mobile charging station (or, mobile electric vehicle charging vehicle). A plurality of mobile charging stations may perform the reinforcement learning in the environment where they interact with each other.

The multi-agent reinforcement learning-based mobile electric vehicle charging service operation apparatus 100 may model the environment. In mobile electric vehicle charging service, the road network, the location of the charging station, the user demand pattern, the battery state of electric vehicle, or the like may be considered.

The multi-agent reinforcement learning-based mobile electric vehicle charging service operation apparatus 100 may design the agents, which are entities acting in the system. Each agent may be the mobile charging station.

The action of the agents may include usage of the charging station, setting of the travel path, providing and finishing of the charging service, or the like.

In other words, the action of the agents may include an action of receiving an electric vehicle charging request of the electric vehicle users and performing corresponding charging request. Additionally, the action of the agents may include an action of predicting future situations to move to a location where the charging demand may occur and waiting.

The multi-agent reinforcement learning-based mobile electric vehicle charging service operation apparatus 100 may define a state and action space of the agent.

Each agent may determine the action based on the observable state. The state of the mobile charging station may include current location, battery level, destination, or the like. The action space is a set of actions including charging, moving, or waiting that may be taken by each agent.

The multi-agent reinforcement learning-based mobile electric vehicle charging service operation apparatus 100 may define the reward function.

The multi-agent reinforcement learning-based mobile electric vehicle charging service operation apparatus 100 may define the reward function based on the goal of the system. In the case of the mobile electric vehicle charging service, the reward in consideration of the charging amount, the travel distance, the user satisfaction, or the like may be defined.

The multi-agent reinforcement learning-based mobile electric vehicle charging service operation apparatus 100 may select an algorithm that is most appropriate for the environment from among various multi-agent reinforcement learning algorithms.

For example, the multi-agent reinforcement learning-based mobile electric vehicle charging service operation apparatus 100 may select the algorithm from Multi-Agent Deep Deterministic Policy Gradient (MADDPG), Q-value Mixing Network (QMIX), counterfactual multi-agent (COMA) Policy Gradients, or the like.

The multi-agent reinforcement learning-based mobile electric vehicle charging service operation apparatus 100 may collect the accumulated learning data through repetitive learning using an algorithm.

For example, the multi-agent reinforcement learning-based mobile electric vehicle charging service operation apparatus 100 may train the agents by using simulations, and may obtain the accumulated learning data.

The multi-agent reinforcement learning-based mobile electric vehicle charging service operation apparatus 100 may distribute or dispose the mobile charging station (corresponding to the agent) of which the training is completed based on the accumulated learning data in order to satisfy the actual charging demand.

At step S240, the multi-agent reinforcement learning-based mobile electric vehicle charging service operation apparatus 100, utilizing a multi-agent reinforcement learning model, may calculate the expected profit and cost associated with the deployment of the mobile charging stations. These calculations are based on deployment of the mobile charging stations and the electric vehicle charging demand.

FIG. 3 is a flowchart showing a method for disposing the mobile charging station using the multi-agent reinforcement learning model through the multi-agent reinforcement learning-based mobile electric vehicle charging service method.

The multi-agent reinforcement learning-based mobile electric vehicle charging service method of FIG. 3 may be performed through the multi-agent reinforcement learning-based mobile electric vehicle charging service operation apparatus 100 (see FIG. 1).

In FIG. 3, at step S310, the multi-agent reinforcement learning-based mobile electric vehicle charging service operation apparatus 100 may provide the trained multi-agent reinforcement learning model based on the electric vehicle charging demand information and state information of the mobile charging station, to generate the optimal deployment of the mobile charging station.

The multi-agent reinforcement learning-based mobile electric vehicle charging service operation apparatus 100 may detect the state of the mobile charging station, determine an action of the mobile charging station based on the state including the electric vehicle charging demand and a location of the mobile charging station. Additionally, the multi-agent reinforcement learning-based mobile electric vehicle charging service operation apparatus 100 may pay the reward with respect to the result based on the determined action.

The result may include the charging profit and the moving cost based on an action of an electric vehicle charging station. The reward may be a feedback with respect to the result that the agent receives from the environment after taking a specific action in a specific state.

The agent may evaluate how much its action is good or bad, through this feedback. In other words, as the result to the action is better, the reward may become greater.

For example, if the result of maximizing the charging profit and minimizing the moving cost is obtained based on the action of the electric vehicle charging station or the agent, the multi-agent reinforcement learning-based mobile electric vehicle charging service operation apparatus 100 may provide the maximum reward with respect to the corresponding action and result.

The multi-agent reinforcement learning-based mobile electric vehicle charging service operation apparatus 100 may train the multi-agent reinforcement learning model with the learning data storing and accumulating the action, the result, and the reward as the learning data.

The multi-agent reinforcement learning-based mobile electric vehicle charging service operation apparatus 100 may provide the multi-agent reinforcement learning model trained as such.

At step S320, when the electric vehicle charging request is received, the multi-agent reinforcement learning-based mobile electric vehicle charging service operation apparatus 100 may dispose the mobile charging station by using the multi-agent reinforcement learning model.

In other words, the multi-agent reinforcement learning-based mobile electric vehicle charging service operation apparatus 100 may dispose the mobile charging station at a location to maximize the charging profit based on a movement of the mobile charging station and the provision of the charging service and minimize the moving cost, by using the multi-agent reinforcement learning model.

The multi-agent reinforcement learning-based mobile electric vehicle charging service operation apparatus 100 may dispose the mobile electric vehicle charging vehicle in a region of high electric vehicle charging demand by time zone using the multi-agent reinforcement learning model.

In an embodiment, the multi-agent reinforcement learning-based mobile electric vehicle charging service operation apparatus 100 may move the plurality of mobile charging stations based on a plurality of electric vehicle charging demands provided at each grid in an N×M grid environment, respectively, and may provide the charging service.

The N×M grid environment may be an environment modeling the actual environment by using the grid.

The multi-agent reinforcement learning-based mobile electric vehicle charging service operation apparatus 100 may calculate the plurality of electric vehicle charging demands and the plurality of mobile charging stations as a 2-dimension matrix matching the N×M grid environment, in the N×M grid environment.

In other words, the plurality of electric vehicle charging demands and states of the plurality of mobile charging stations may be represented as a 2-dimension matrix in the grid environment based on the situation.

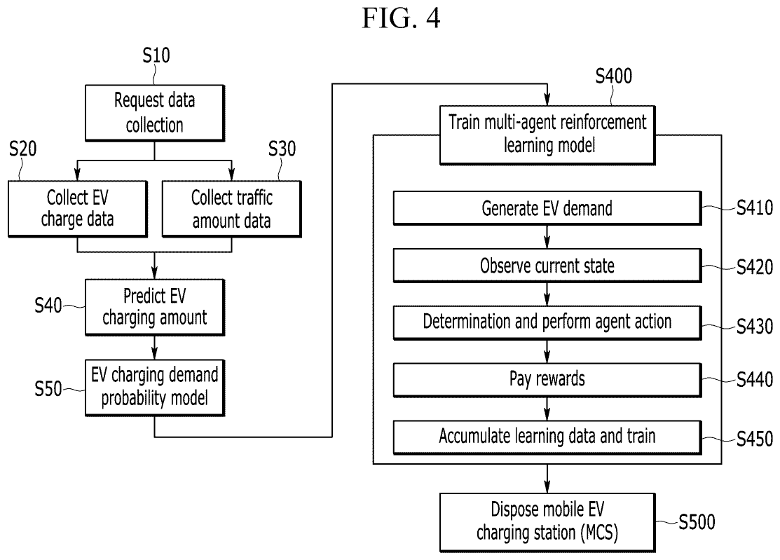

FIG. 4 is a flowchart of the multi-agent reinforcement learning-based mobile electric vehicle charging service method according to an embodiment. FIG. 4 shows a specific method for training the multi-agent reinforcement learning model.

The multi-agent reinforcement learning-based mobile electric vehicle charging service method of FIG. 4 may be performed through the multi-agent reinforcement learning-based mobile electric vehicle charging service operation apparatus 100 (see FIG. 1).

In FIG. 4, at step S10 to step S50, the multi-agent reinforcement learning-based mobile electric vehicle charging service operation apparatus 100 may generate the electric vehicle charging demand probability model.

In particular, at step S10, the multi-agent reinforcement learning-based mobile electric vehicle charging service operation apparatus 100 may request data collection through a data collection system.

At step S20, the multi-agent reinforcement learning-based mobile electric vehicle charging service operation apparatus 100 may collect the electric vehicle charging demand data through the data collection system.

At step S30, at the same time, the multi-agent reinforcement learning-based mobile electric vehicle charging service operation apparatus 100 may collect an amount of traffic data.

At step S40, the multi-agent reinforcement learning-based mobile electric vehicle charging service operation apparatus 100 may perform prediction of a future electric vehicle charging amount by utilizing the secured electric vehicle charging demand information and the traffic amount information.

The multi-agent reinforcement learning-based mobile electric vehicle charging service operation apparatus 100 may generate a charging amount prediction model that predicts the charging amount through various artificial intelligence models including machine-learning and deep learning.

At step S50, the multi-agent reinforcement learning-based mobile electric vehicle charging service operation apparatus 100 may generate the electric vehicle charging demand probability model based on the predicted future electric vehicle charging amount.

In other words, the multi-agent reinforcement learning-based mobile electric vehicle charging service operation apparatus 100 may predict the demand for the mobile electric vehicle charging service through the generated prediction information and the collected data, to generate a final EV charging demand probability model.

The multi-agent reinforcement learning-based mobile electric vehicle charging service operation apparatus 100 may utilize various probability variables including Poisson distribution or the like, for the electric vehicle charging demand probability model.

At step S400, the multi-agent reinforcement learning-based mobile electric vehicle charging service operation apparatus 100 may train the multi-agent reinforcement learning model taking the mobile charging station as the agent in the environment including the electric vehicle charging demand generated through the electric vehicle charging demand probability model.

At step S410, the multi-agent reinforcement learning-based mobile electric vehicle charging service operation apparatus 100 may generate the electric vehicle charging demand by using the electric vehicle charging demand probability model, in order for training of the multi-agent reinforcement learning model.

At step S420, the multi-agent reinforcement learning-based mobile electric vehicle charging service operation apparatus 100 may detect the state of the currently disposed mobile charging station.

At step S430, the multi-agent reinforcement learning-based mobile electric vehicle charging service operation apparatus 100 may determine the action of each mobile charging station that is the agent based on the generated the electric vehicle charging demand and the state of the currently disposed mobile charging station.

The multi-agent reinforcement learning-based mobile electric vehicle charging service operation apparatus 100 may determine the action through the reinforcement learning model including Deep Q Network, Dueling Q Network, and Actor-Critic Model.

The multi-agent reinforcement learning-based mobile electric vehicle charging service operation apparatus 100 may also utilize various decision-making policies (Epsilon Greedy, Softmax, or the like), depending on the utilized reinforcement learning model.

In an embodiment, the multi-agent reinforcement learning-based mobile electric vehicle charging service operation apparatus 100 may determine the action of the mobile charging station in consideration of the current status of other agents and the action information pieces to be determined thereto together, in addition to the electric vehicle charging demand and deployment of corresponding mobile charging stations in order to consider the multi-agent environment.

At step S440, the multi-agent reinforcement learning-based mobile electric vehicle charging service operation apparatus 100 may pay the reward based on the result according to the action of the mobile charging station having performed the determined action.

The multi-agent reinforcement learning-based mobile electric vehicle charging service operation apparatus 100 may calculate a future value based on the action of the mobile charging station and the electric vehicle charging demand, respectively. Additionally, the multi-agent reinforcement learning-based mobile electric vehicle charging service operation apparatus 100 may pay the reward with respect to the action in proportion to the calculated future value.

When the reward is not defined clearly and appropriately in the reinforcement learning, the agent may learn an undesired action. In other words, the reward needs to be clearly defined, such that the agent may be induced to achieve the desired goal.

The multi-agent reinforcement learning-based mobile electric vehicle charging service operation apparatus 100 may determine the reward to be payed through Equation 1 below.

$${R}_{Agent} = {R}_{Action} + {R}_{State} \qquad [ Equation 1 ]$$

The agent means the mobile charging station, R_{Agent} means the reward obtained by respective agents, R_{Action} is an agent action reward, R_{State} is an agent state reward, R_{Action} is proportional to a charging service providing profit, and inversely proportional to an agent moving cost, and R_{State} is proportional to the number of remaining electric vehicles desired for charging and inversely proportional to the number of the agents.

The charging service providing profit may mean the charging profit that the current agent obtains by providing the charging service to the electric vehicle. Additionally, the charging service providing profit may be simplified as a similar value for efficient training during the process of training.

The agent moving cost may mean the energy cost incurred by the agent when the agent decides to move. Since this is a cost, there is a tendency to minimize it, and it may become inversely proportional to the agent action reward. The agent moving cost may be simplified as a similar value for efficient learning during the training process.

The agent state reward is an item included to persuate the charging action of the agents, and may be a reward utilized only during the process of training.

The agent state reward may be calculated according to Equation 2 below.

$${R}_{State} = - α \times ( \# EVs Remaining ) / ( \# Agent ) \qquad [ Equation 2 ]$$

#EVs Remaining indicates the number of remaining electric vehicles requiring charging, #Agent indicates the current number of agents, and the variable α indicates an arbitrary coefficient. The variable a may be adjusted to induce efficient learning.

In other words, the agent state reward may be proportional to the number of electric vehicles requiring charging remaining in the current situation, and may be inversely proportional to the number of the agents.

At step S450, the multi-agent reinforcement learning-based mobile electric vehicle charging service operation apparatus 100 may store and accumulate the action, the result, and the reward as the learning data.

For example, the multi-agent reinforcement learning-based mobile electric vehicle charging service operation apparatus 100 may generate the electric vehicle charging demand based on the flow of time in the N×M grid environment for accumulation of the learning data. Additionally, the apparatus 100 may perform a simulation generating the reward based on the movement of the mobile charging station and provision of the charging service.

The multi-agent reinforcement learning-based mobile electric vehicle charging service operation apparatus 100 may calculate the electric vehicle charging demand and the deployment of the mobile charging stations as a 2-dimension matrix matching the N×M grid environment.

The multi-agent reinforcement learning-based mobile electric vehicle charging service operation apparatus 100 may calculate both the charging profit and the moving cost based on the movement of the mobile charging station and the provision of the charging service.

The multi-agent reinforcement learning-based mobile electric vehicle charging service operation apparatus 100 may determine the reward based on the calculated charging profit and the moving cost.

At step S400, the multi-agent reinforcement learning-based mobile electric vehicle charging service operation apparatus 100 may train the multi-agent reinforcement learning model with the accumulated learning data.

The multi-agent reinforcement learning-based mobile electric vehicle charging service operation apparatus 100 may train the multi-agent reinforcement learning model in a direction to maximize the reward through repetitive simulation.

For example, if the result of maximizing the charging profit and minimizing the moving cost is obtained based on the action of the electric vehicle charging station or the agent, the multi-agent reinforcement learning-based mobile electric vehicle charging service operation apparatus 100 may determine the maximum reward with respect to the corresponding action and result. In other words, the multi-agent reinforcement learning-based mobile electric vehicle charging service operation apparatus 100 may repeat the corresponding learning process until the time point of completing the training.

At step S500, the multi-agent reinforcement learning-based mobile electric vehicle charging service operation apparatus 100 may dispose the mobile charging station by using the trained multi-agent reinforcement learning model.

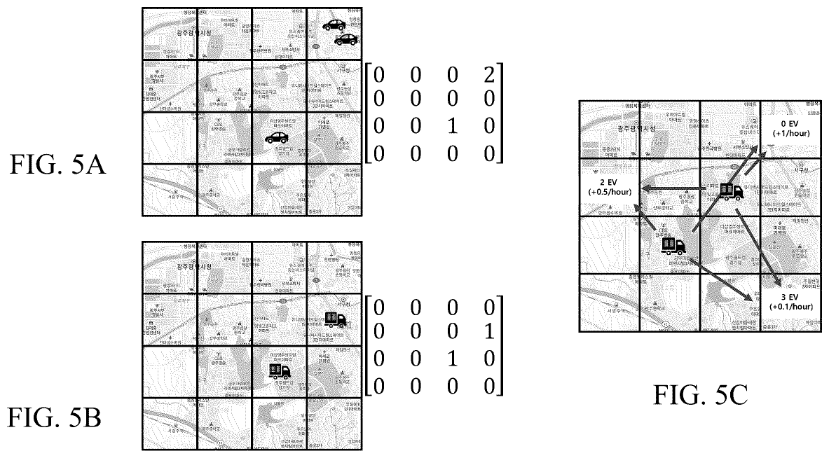

FIGS. 5A, 5B, and 5C are example diagrams explaining the multi-agent reinforcement learning-based mobile electric vehicle charging service method according to an embodiment.

FIGS. 5A, 5B, and 5C show a 2-dimension matrix calculated by matching the N×M grid environment and the N×M grid environment, in the simulation or actual application of the multi-agent reinforcement learning model.

FIG. 5A represents the current electric vehicle charging demand in the N×M grid environment that is map-based modeled. The displayed vehicle may represent the electric vehicle charging demand. The electric vehicle charging demand may be intuitively shown as numbers in the matrix.

FIG. 5B shows a current deployment status of the mobile charging station. Through the displayed mobile charging station and numbers in the matrix, the current location of the mobile charging station may be intuitively known.

In addition, information pieces such as the traffic amount or action information between different agents may be represented as a multi-dimensional matrix.

Information such as the traffic amount or action information between different agents represented as the matrix, the electric vehicle charging demand information, and deployment of the mobile charging stations state information may be used as an input of the artificial intelligence model including the multi-agent reinforcement learning model.

FIG. 5C shows that the agent (the mobile charging station) determines the action of moving for charging in the grid environment.

The multi-agent reinforcement learning-based mobile electric vehicle charging service operation apparatus 100 may select the optimal action through information including the action of other nearby agents among selections (arrows) available in the situation as in FIG. 5C, through the multi-agent reinforcement learning model.

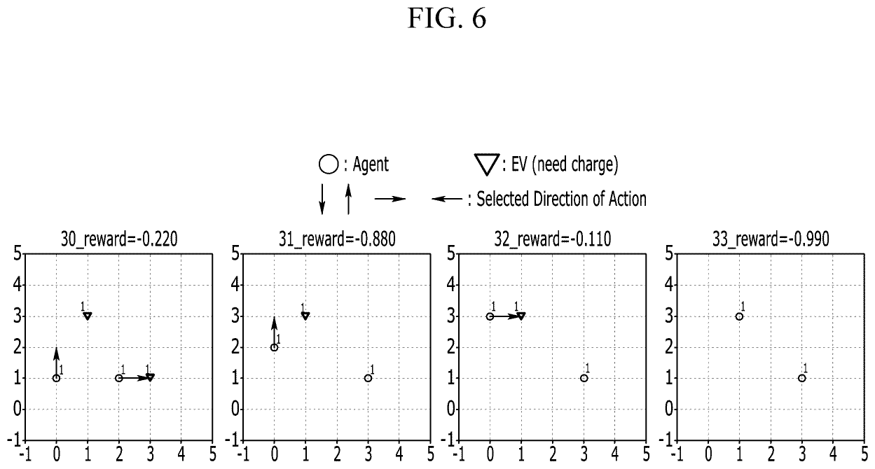

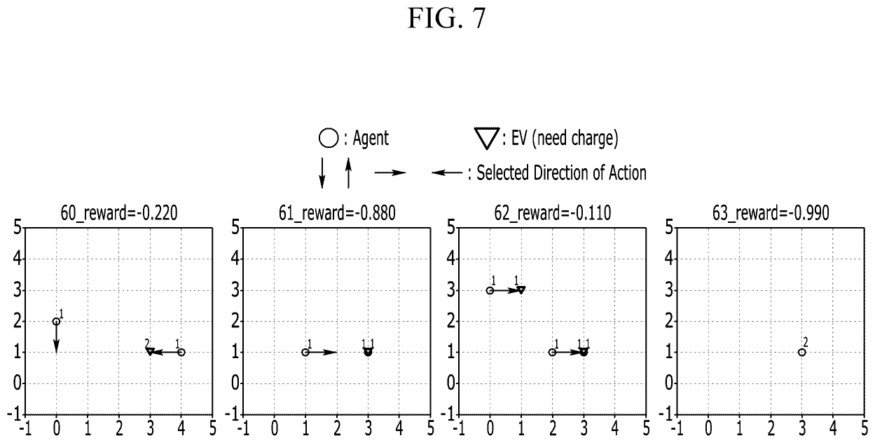

FIGS. 6 and 7 are drawings showing the results obtained through the multi-agent reinforcement learning-based mobile electric vehicle charging service method according to an embodiment.

FIG. 6 is a diagram showing travel paths of the agents of which the training is completed. In FIG. 6, it may be confirmed that the respective agents are distributed to move toward the electric vehicle requiring charging.

Two electric vehicles requiring charging may be disposed at different locations. The mobile charging stations may move to provide the charging services to nearby electric vehicles, respectively. When each of the mobile charging stations arrives at the nearby electric vehicle, the reward 0.990 may be the maximum.

FIG. 7 is a diagram showing travel paths of the agents of which the training is completed. In FIG. 7, it may be confirmed that, unlike FIG. 6, the plurality of mobile charging stations provide the charging service with respect to the electric vehicle charging demand concentrated in one location.

Two electric vehicles requiring charging are located in the same locations. Two mobile charging stations in different locations may move to the same locations in order to provide the charging service.

The two mobile charging stations may move to the electric vehicles through optimal routes, respectively.

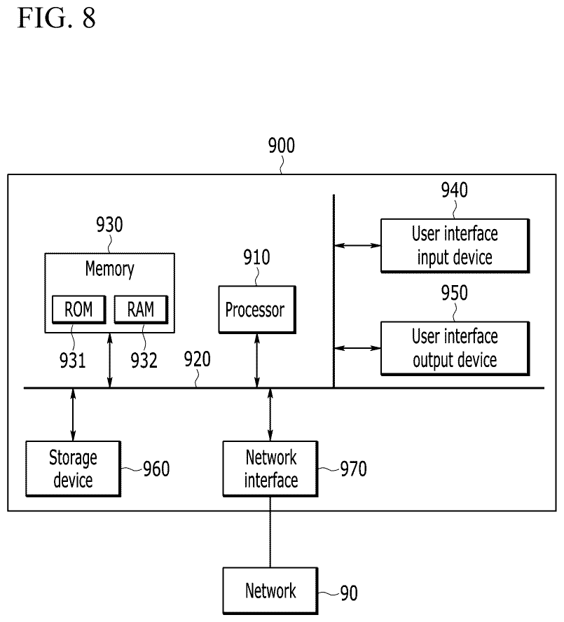

FIG. 8 is drawing explaining a computing device according to an embodiment.

Referring to FIG. 8, the multi-agent reinforcement learning-based mobile electric vehicle charging service method according to embodiments may be implemented by using a computing device 900.

The computing device 900 may include at least one of a processor 910, a memory 930, the user interface input device 940, the user interface output device 950, and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like. Additionally, the processor 910 may be any type of semiconductor device capable of executing instructions stored in the memory 930 or the storage device 960. The processor 910 may be configured to implement the functions and methods described above with respect to FIGS. 1 to 7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some configurations or functions of the multi-agent reinforcement learning-based mobile electric vehicle charging service method according to an embodiment may be implemented as a program or software executable by the computing device 900, and program or software may be stored in a computer-readable medium.

In some embodiments, at least some configurations or functions of the multi-agent reinforcement learning-based mobile electric vehicle charging service method according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it is to be understood that the disclosure is not limited to the disclosed embodiments. Instead the present disclosure is intended to cover various modifications and equivalent arrangements included within the spirit and scope of the appended claims.

### DESCRIPTION OF SYMBOLS

10: mobile charging station current location
20: locations of electric vehicles
100: multi-agent reinforcement learning-based mobile electric vehicle charging service operation apparatus

What is claimed is:

1. A multi-agent reinforcement learning-based mobile electric vehicle charging service method, the method comprising:
generating an electric vehicle charging demand;
detecting a state of a mobile charging station;
determining an action of the mobile charging station including moving or waiting based on the electric vehicle charging demand and the state of the mobile charging station;
paying a reward as feedback to a result including a charging profit and a moving cost based on the determined action;
storing and accumulating the action, the result, and the reward as learning data; and
training a multi-agent reinforcement learning model for generating an optimal deployment of the mobile charging station by using the accumulated learning data.

2. The method of claim 1, wherein generating the electric vehicle charging demand comprises:
collecting data with respect to the electric vehicle charging demand and a traffic amount;
predicting an electric vehicle charging amount through an artificial intelligence model based on the collected data;
generating an electric vehicle charging demand probability model based on the predicted electric vehicle charging amount; and
generating the electric vehicle charging demand by using the generated electric vehicle charging demand probability model.

3. The method of claim 2, wherein the electric vehicle charging demand probability model comprises a Poisson distribution model.

4. The method of claim 1, wherein determining the action of the mobile charging station comprises determining the action through the multi-agent reinforcement learning model including a Deep Q Network, a Dueling Q Network, and an Actor-Critic Model.

5. The method of claim 1, wherein paying the reward comprises:
calculating a future value based on the action of the mobile charging station and the electric vehicle charging demand, respectively; and
paying the reward with respect to the action in proportion to the calculated future value.

6. The method of claim 1, wherein paying the reward comprises determining the reward based on Equation 1:
$${R}_{Agent} = {R}_{Action} + {R}_{State} ,$$
wherein agent is an electric vehicle charging station, R_{Agent} is the reward obtained by respective agents, R_{Action} is an agent action reward, and R_{State} is an agent state reward, and
wherein R_{Action} is proportional to a charging service providing profit, and inversely proportional to an agent moving cost, and R_{State} is proportional to a number of remaining electric vehicles for charging and inversely proportional to a number of agents.

7. The method of claim 1, wherein accumulating as the learning data comprises:
performing a simulation to generate the electric vehicle charging demand over time in an N×M grid environment and to generate the reward based on a movement of the mobile charging station and provision of a charging service, for accumulation of the learning data.

8. The method of claim 7, wherein performing the simulation comprises:
calculating the electric vehicle charging demand and a deployment of the mobile charging stations as a 2-dimension matrix matching the N×M grid environment.

9. The method of claim 7, wherein performing the simulation further comprises:
calculating both the charging profit and the moving cost based on the movement of the mobile charging station and the provision of the charging service; and
determining the reward based on the calculated charging profit and the moving cost.

10. The method of claim 9, wherein training the multi-agent reinforcement learning model further comprises training the multi-agent reinforcement learning model in a direction to maximize the reward through repetitive simulation.

11. A multi-agent reinforcement learning-based mobile electric vehicle charging service method, the method comprising:
providing a multi-agent reinforcement learning model trained based on electric vehicle charging demand information and state information of a mobile charging station to generate an optimal deployment of mobile charging stations; and
disposing the mobile charging station by using the multi-agent reinforcement learning model, when an electric vehicle charging request is received.

12. The method of claim 11, wherein disposing the mobile charging station comprises providing a charging service by moving a plurality of mobile charging stations, respectively, based on a plurality of electric vehicle charging demands provided at each grid in an N×M grid environment.

13. The method of claim 12, wherein the plurality of electric vehicle charging demands and the plurality of mobile charging stations in the N×M grid environment are provided as a 2-dimensional matrix matching the N×M grid environment.

14. The method of claim 11, wherein disposing the mobile charging station comprises:
disposing the mobile charging station at a location to maximize a charging profit based on a movement of the mobile charging station and a provision of a charging service, and to minimize a moving cost, by using the multi-agent reinforcement learning model.

15. The method of claim 11, wherein providing the multi-agent reinforcement learning model comprises training the multi-agent reinforcement learning model, and
wherein training the multi-agent reinforcement learning model comprises:
detecting a state of the mobile charging station;
determining an action of the mobile charging station including moving or waiting based on the electric vehicle charging demand and the state of the mobile charging station;
paying a reward as a feedback with respect to a result having a charging profit and a moving cost based on the determined action;
storing and accumulating the action, the result, and the reward as learning data; and
training the multi-agent reinforcement learning model for generating the optimal deployment of the mobile charging station by using the accumulated learning data.

16. The method of claim 15, wherein generating the electric vehicle charging demand comprises:
collecting data with respect to the electric vehicle charging demand and a traffic amount;
predicting an electric vehicle charging amount through an artificial intelligence model based on the collected data;
generating an electric vehicle charging demand probability model based on the predicted electric vehicle charging amount; and
generating the electric vehicle charging demand by using the generated electric vehicle charging demand probability model.

17. The method of claim 15, wherein determining the action of the mobile charging station comprises determining the action through the multi-agent reinforcement learning model including a Deep Q Network, a Dueling Q Network, and an Actor-Critic Model.

18. The method of claim 15, wherein paying the reward comprises:
calculating a future value including the charging profit based on the action of the mobile charging station and the electric vehicle charging demand, respectively; and
paying the reward with respect to the action in proportion to the calculated future value.

19. The method of claim 15, wherein paying the reward comprises determining the reward based on Equation 1:
$${R}_{Agent} = {R}_{Action} + {R}_{State} ,$$
wherein agent is an electric vehicle charging station, R_{Agent} is the reward obtained by respective agents, R_{Action} is an agent action reward, and R_{State} is an agent state reward, and wherein R_{Action} is proportional to a charging service providing profit, and is inversely proportional to an agent moving cost, and R_{State} is proportional to a number of remaining electric vehicles for charging and inversely proportional to a number of agents.

20. The method of claim 15, wherein training the multi-agent reinforcement learning model comprises:
performing a simulation to generate the electric vehicle charging demand over time in an N×M grid environment, and to generate the reward based on a movement of the mobile charging station and provision of a charging service, for accumulation of the learning data.
